(19) United States
(12) Patent Application Publication
(10) Pub. No.: US 2005/0086114 A1
(43) Pub. Date: Apr. 21, 2005

(54) Computer product and apparatus for supporting activities of sales promotion and advertisement

(75) Inventors: Seiichi Mashimo, Kawasaki (JP); Hiroyuki Hatta, Kawasaki (JP); Kenichi Takahashi, Tokyo (JP); Masayuki Okuno, Tokyo (JP); Eiichi Ichimura, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/005,101

(22) Filed: Dec. 7, 2004

Related U.S. Application Data
(63) Continuation of application No. PCT/JP03/07278, filed on Jun. 9, 2004.

(30) Foreign Application Priority Data
Jun. 7, 2002 (JP) 2002-167732

(51) Int. Cl. G06F 17/60

(52) U.S. Cl. 705/14

(57) ABSTRACT

A method for supporting activities of a sales promotion and an advertisement for contents performed by a contents provider through a mass-media institution includes receiving first contents information provided by the contents provider; receiving request information for use of contents information from the mass-media institution; extracting second contents information that corresponds to the request information from among the first contents information; transmitting the second contents information to the mass-media institution; receiving usage information on a record of an actual use of the second contents information by the mass-media institution; and calculating a cost to be paid to the mass-media institution based on the usage information.

### BACKGROUND OF THE INVENTION

1). Field of the Invention

The present invention relates to a technology for supporting activities of sales promotion and advertisement that supports sales promotion or advertisement for works (contents) using the Internet and mass media institutions.

2). Description of the Related Art

Agencies and record companies to which musicians that produce works including music belong, promote sales of products, such as a compact disc (CD), by allocating advertising expenses for requesting broadcasting stations, such as radio stations, to effectively broadcast music that is included in the CD.

Conventionally, there are three methods when such agencies and record companies request broadcasting stations to broadcast their music for a purpose of advertising the music.

Without an advertisement (publicity base), the record companies provide CDs, documents, and advertising materials to producers at the broadcasting stations and production companies. Expenses paid by the record companies include personnel expenses for a promoter, cost for preparing advertising material such as CDs, delivery cost, entertainment expenses, and conference expenses.

With an advertisement by radio spot advertising, the record companies provide advertising expenses (fees for a single radio spot of 20 second×number of advertisements) and commercial materials for the radio spot to the broadcasting stations. It is often strongly requested that the music be broadcasted during a program in addition to the radio spot.

With an advertisement by sponsoring a program or providing a sound source, the record companies provide advertising expenses to the broadcasting stations. Additionally, it may be requested that the music be broadcasted in another program that is not sponsored.

However, the above methods are executed manually, based on ambiguous standards for each time, and no method nor system for such advertisement and promotion has been established. Advertising expenses are also determined by the broadcasting station, or based on the agreement between the broadcasting station and an advertising agency, considering the power relationship (hereinafter, “station power”) based on an area that is covered by the broadcasting station, a number of audiences, and a time window for the broadcasting.

For example, in a case without an advertisement, the personnel expenses and the entertainment expenses are required other than the cost for preparing the advertising material and a sample CD. However, if there is no broadcasting frame available for the music, the music is not broadcasted. Additional expenses is further required depending on a case.

In cases with an advertisement, even if a budget is allocated for the advertisement, the budget may be used for a radio spot advertisement of about 20 seconds for broadcasting, or used as a part of the production cost for a program. It may cost more than actually necessary. Therefore, it is difficult to systematically allocate the budget. Although a purpose is to broadcast the music for the advertisement and the promotion, the budget prepared for the purpose is used for a different purpose. Therefore, counter value directly to the broadcasting cannot be realized.

Furthermore, since it is not clear in which program the music is broadcasted, it cannot be accurately confirmed whether the music is actually broadcasted. Therefore, it is quite difficult to precisely judge the effect.

On the other hand, a small broadcasting station may not be able to broadcast the music, since the small broadcasting station does not have a sound source of the music, such as a CD, even if the small broadcasting station wishes to broadcast the music recommended. Furthermore, such small broadcasting station cannot efficiently collect expenses from the record companies, although the expenses are expected as the operation expenses of the small broadcasting station.

Moreover, works that can be a target of an advertisement and a sales promotion are limited. For example, the works are limited to such works that 15,000 or more discs of CDs have been released in the past. In addition, handling of such works is always changing depending on a manufacturer's strategy. Furthermore, the human-wave tactics of the promoter concentrate on metropolitan areas, and local areas are not covered sufficiently.

To realize an efficient advertisement and sales promotion that meet the advertising expenses, database cooperation for managing music and advertising expenses is important.

### SUMMARY OF THE INVENTION

It is an object of the present invention to solve at least the above problems in the conventional technology.

A method for supporting activities of a sales promotion and an advertisement for contents that are performed by a contents provider through a mass-media institution according to one aspect of the present invention includes receiving first contents information provided by the contents provider; receiving request information for use of the contents information from the mass-media institution; extracting second contents information that corresponds to the request information from among the first contents information; transmitting the second contents information to the mass-media institution; receiving usage information on a record of an actual use of the second contents information by the mass-media institution; and calculating a cost to be paid to the mass-media institution by the contents provider based on the usage information received.

A method for supporting activities of a sales promotion and an advertisement for contents that are performed by a contents provider through a mass-media institution according to another aspect of the present invention includes receiving first contents information provided by the contents provider and contents providing information on the sales promotion and the advertisement of the contents information including specifying information for specifying a single mass-media institution or a plurality of mass-media institution; receiving request information for use of the contents information from the mass-media institution specified; extracting second contents information that corresponds to the request information from among the first contents information; transmitting the second contents information to the mass-media institution; receiving usage information on a record of an actual use of the second contents information by the mass-media institution; and calculating a cost to be paid to the mass-media institution by the contents provider based on the contents providing information and the usage information received.

A computer program according to still another aspect of the present invention realizes a method for supporting activities of a sales promotion and an advertisement for contents that are performed by a contents provider through a mass-media institution according to the above aspects.

A computer-readable recording medium according to still another aspect of the present invention stores a computer program for supporting activities of a sales promotion and an advertisement for contents that are performed by a contents provider through a mass-media institution according to the above aspects.

An apparatus for supporting activities of a sales promotion and an advertisement for contents that are performed by a contents provider through a mass-media institution according to still another aspect of the present invention includes a first receiving unit that receives first contents information provided by the contents provider; a second receiving unit that receives request information for use of the contents information from the mass-media institution; an extracting unit that extracts second contents information that corresponds to the request information from among the first contents information; a transmitting unit that transmits the second contents information to the mass-media institution; a third receiving unit that receives usage information on a record of an actual use of the second contents information by the mass-media institution; and a calculating unit that calculates a cost to be paid to the mass-media institution by the contents provider based on the usage information received.

An apparatus for supporting activities of a sales promotion and an advertisement for contents that are performed by a contents provider through a mass-media institution according to still another aspect of the present invention includes a first receiving unit that receives first contents information provided by the contents provider and contents providing information on the sales promotion and the advertisement of the contents information including specifying information for specifying a single mass-media institution or a plurality of mass-media institution; a second receiving unit that receives request information for use of the contents information from the mass-media institution specified; a storage unit that stores the contents providing information and the request information; an extracting unit that extracts second contents information that corresponds to the request information from among the first contents information; a transmitting unit that transmits the second contents information to the mass-media institution; a third receiving unit that receives usage information on a record of an actual use of the second contents information by the mass-media institution; and calculating a cost to be paid to the mass-media institution by the contents provider based on the contents providing information and the usage information.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a configuration of a system for supporting sales promotion and advertisement, including an apparatus for supporting sales promotion and advertisement according to an embodiment of the present invention;

FIG. 2 is a table that explains data structure of an administrative database 111;

FIG. 3 is a table that explains data structure of a source database 112;

FIG. 4 is a table that explains data structure of an accounting database 113;

FIG. 5 is a table that explains data structure of a registrant database 114;

FIG. 6 is a table that explains data structure of a user database 115;

FIG. 7 is a table that explains data structure of a clearing database 116;

FIG. 8 is a schematic of hardware configuration of an information processing server 104, and information processing terminal units 105 and 106;

FIG. 9 is a block diagram of a functional configuration of the information processing server 104;

FIG. 10 is a flowchart of a process for contents registration of the apparatus according to the embodiment;

FIG. 11 is a flowchart of a process for notification to a user of the apparatus according to the embodiment;

FIG. 12 is a flowchart of a process for registration of use request information of the apparatus according to the embodiment;

FIG. 13 is a flowchart of a process for transmission of contents of the apparatus according to the embodiment;

FIG. 14 is a flowchart of a process for cost calculation of the apparatus according to the embodiment; and

FIG. 15 is a list of a cumulative audience for programs in a 15-minute-time-window.

### DETAILED DESCRIPTION

Exemplary embodiments of a method and apparatus for supporting sales promotion and advertisement, and a computer product according to the present invention will be explained in detail with reference to the accompanying drawings.

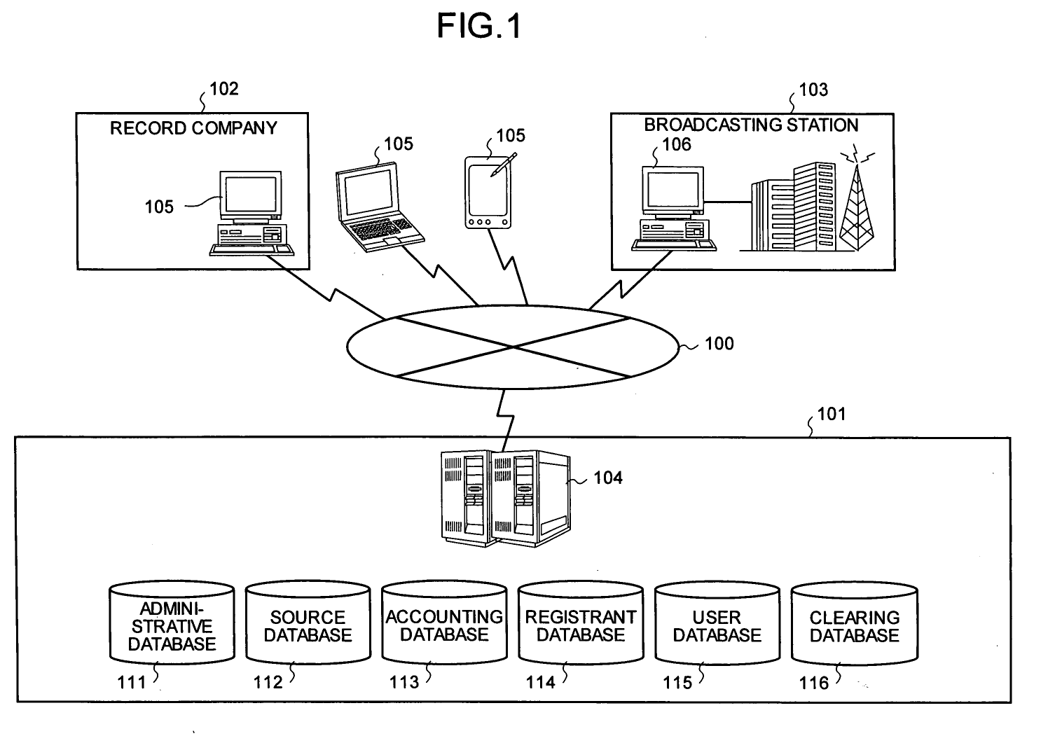

FIG. 1 is a schematic of a configuration of a system for supporting sales promotion and advertisement, including an apparatus for supporting sales promotion and advertisement according to an embodiment of the present invention. As shown in FIG. 1, the system includes a network 100, which includes the Internet, a database center 101, a record company 102 that provides the contents, a broadcasting station 103, which includes a TV station, a radio station, a cable broadcasting station.

The system further includes an information processing server 104, which is the apparatus according to the embodiment, and that is provided in the database center 101, an information-processing terminal unit 105 of a registrant to the record company 102, and an information-processing terminal unit 106 of a user of the broadcasting station 103.

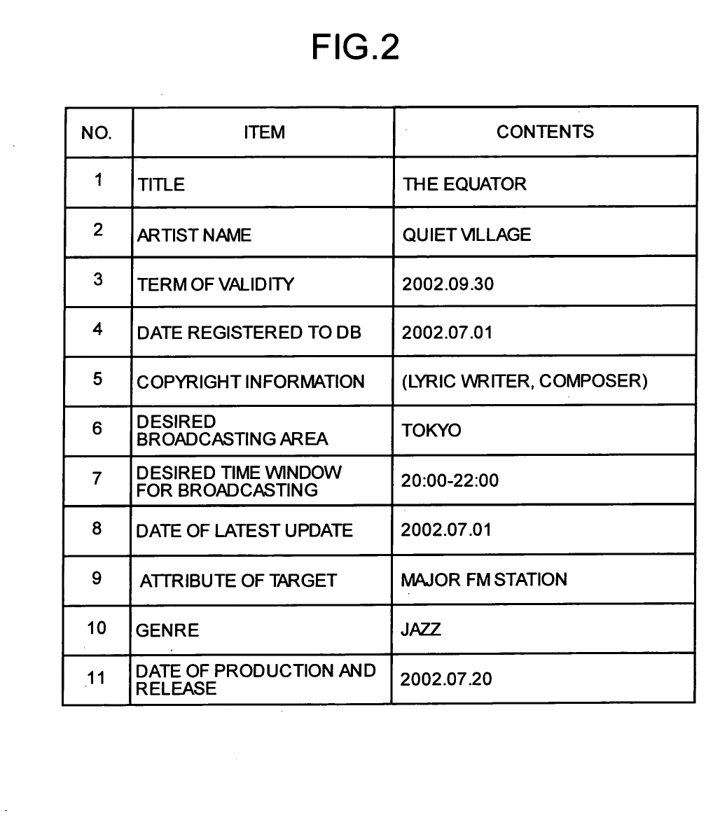

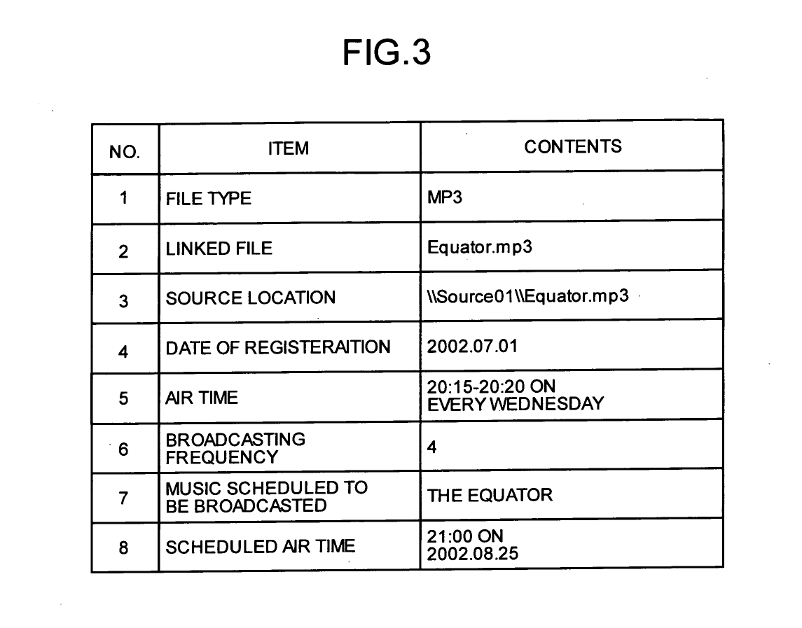

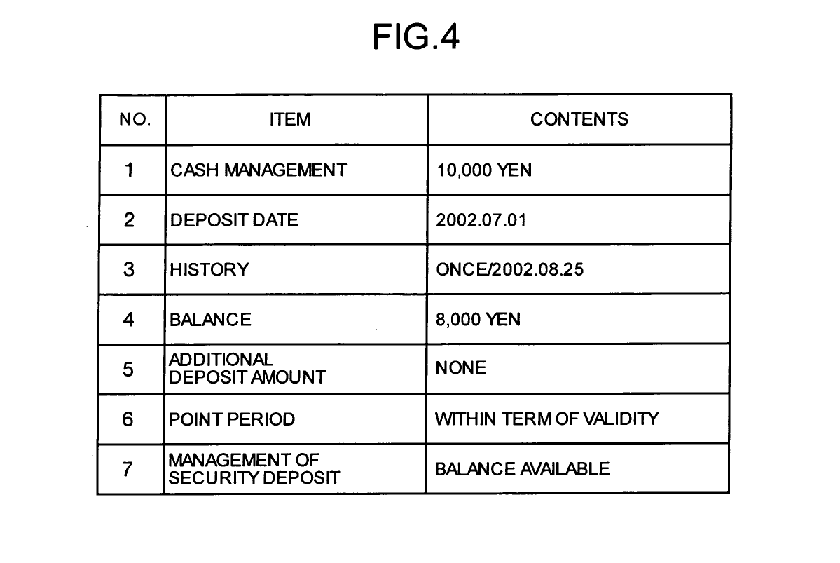

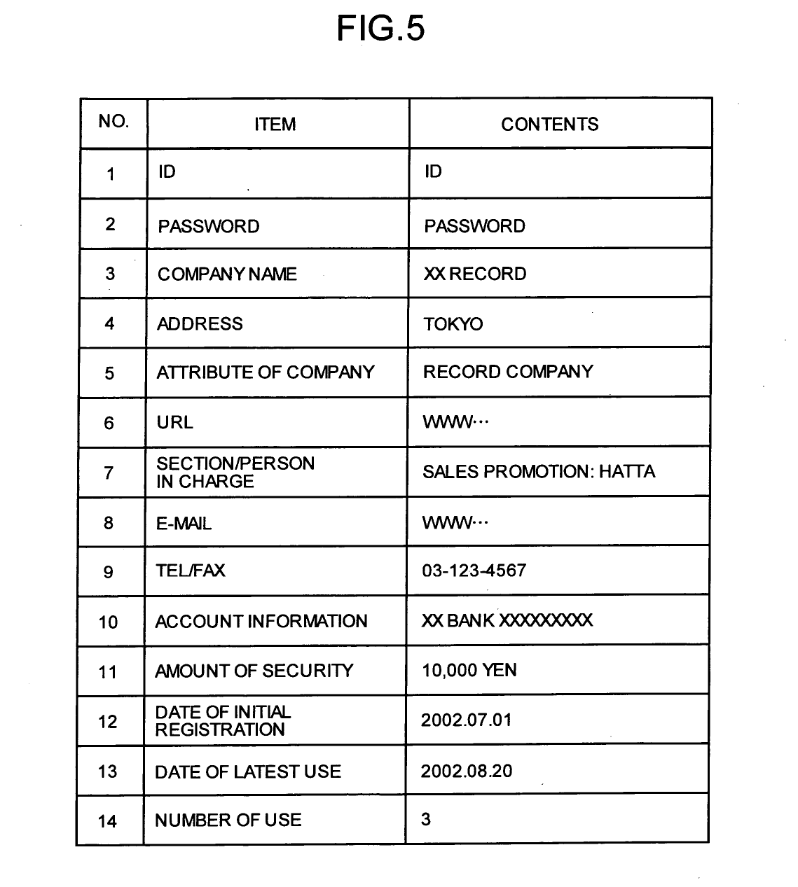

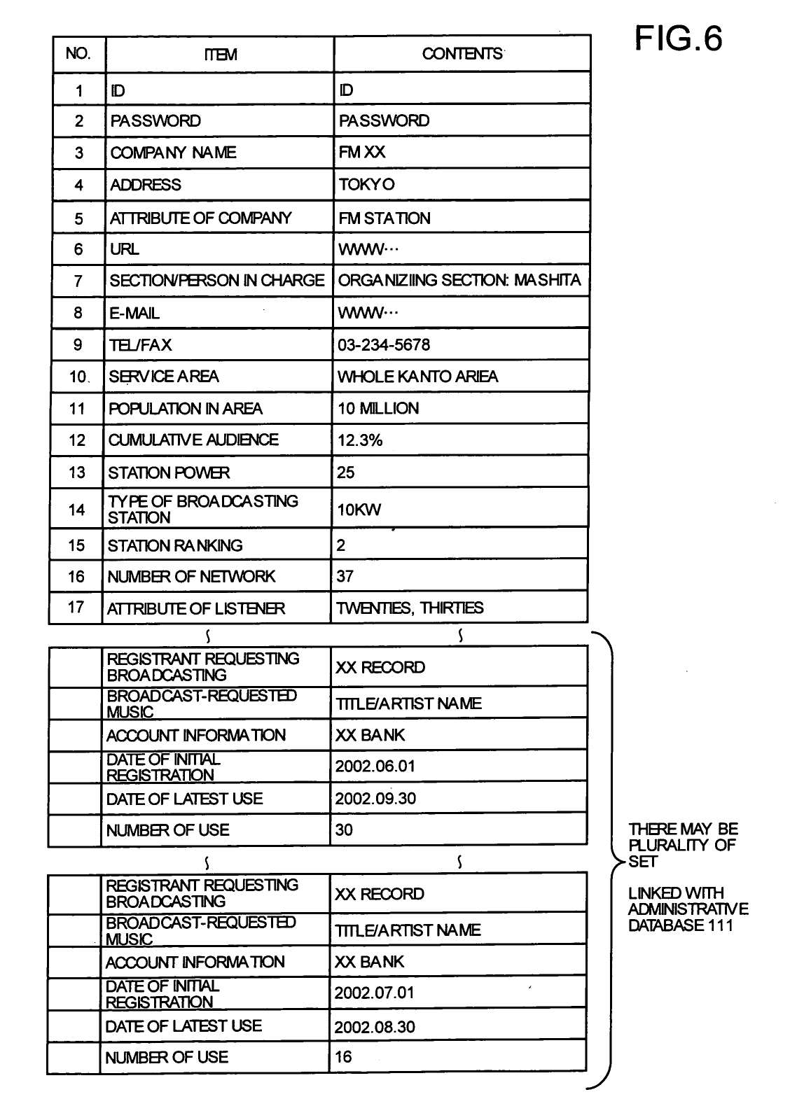

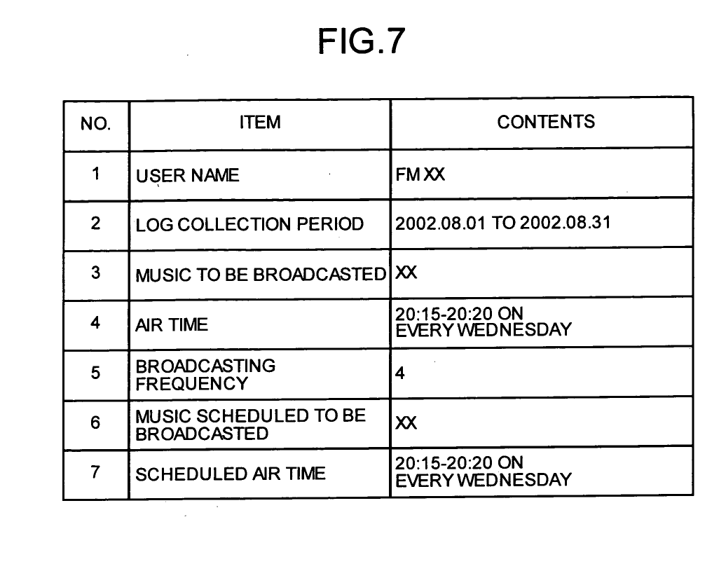

The database center 101 includes database (DB) that is connectable to the information processing server 104. The databases include an administrative database 111 (FIG. 2), a source database 112 (FIG. 3), an accounting database 113 (FIG. 4), a registrant database 114 (FIG. 5), a user database 115 (FIG. 6), and a clearing database 116 (FIG. 7).

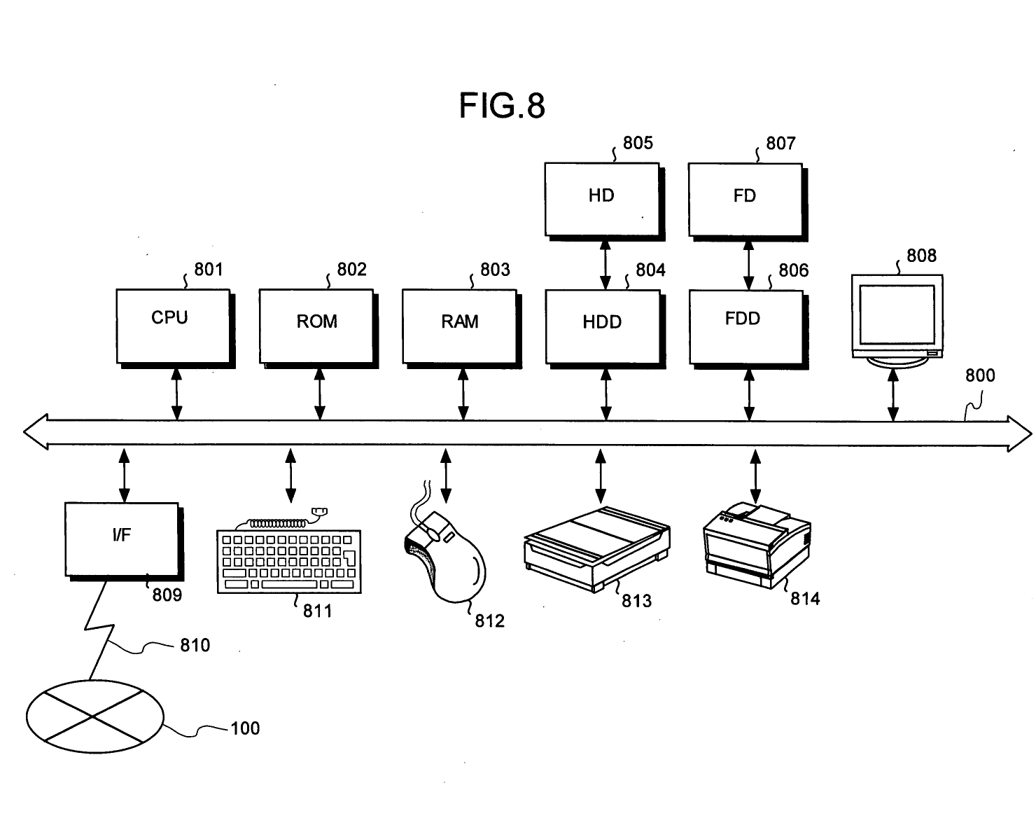

Functions of the databases such as the administrative database 111, the source database 112, the accounting database 113, the registrant database 114, the user database 115, and the clearing database 116 are realized by, for example, a read-only memory (ROM) 802, a random-access memory (RAM) 803, a hard disk (HD) 805, and a flexible disk (FD) 807 shown in FIG. 8. Such databases may be provided in the information processing server 104. Alternatively, such databases may be provided separately from the information processing server 104 in such a manner that the information processing server 104 and the databases can be connected through an Interface (I/F) 809.

The administrative database 111 stores contents providing information transmitted from the information-processing terminal unit 105. A registrant registers information relating to music such as a title, a desired broadcasting area, and a desired time window in the administrative database 111.

As shown in FIG. 2, the administrative database 111 includes information such as a “title” of music (contents), an “artist name”, a “term of validity”, a “date registered to a DB”, a “copyright information, a “desired broadcasting area”, a “desired time window for broadcasting” the music, a “date of latest update”, a “attribute of a target” such as a broadcasting station, a “genre” of the music, a “date of production and release” of the music.

The broadcasting station 103 is determined based on the “attribute of a target” in the administrative database 111. All or a part of information stored in the administrative database 111 is transmitted to the information-processing terminal unit 106 of a user of the broadcasting station 103 determined.

The source database 112 includes source information relating to the contents information, information relating to a use schedule of the contents information, and information relating to an actual use of the contents information. As shown in FIG. 3, in the source database, information on contents such as a “file type”, a “linked file”, a “source location”, a “date of registration”, an “air time”, a “broadcasting frequency”, a “music scheduled to be broadcasted”, a “scheduled air time” are stored.

The accounting database 113 includes data used for cost calculation process and accounting process. The registrant registers an amount of advertising expenses in the accounting database 113. With the accounting database 113, a deposit date, an amount of money, a term of validity of the advertising expenses, and the like are managed. As shown in FIG. 4, in the accounting database 113, information on “cash management” that indicates a current balance, a “deposit date” of the expenses, a “history” of payment of the expenses, a “balance” of the expenses, an “additional deposit amount”, a “point period” regarding the term of validity of the advertising expenses, “management of a security deposit” are stored.

The registrant database 114 includes information relating to the registrant. The registrant registers a company name, an address, a person in charge, account information, and the like in the registrant database 114. As shown in FIG. 5, in the registrant database 114, information on the registrant such as an “identification (ID)”, a “password”, a “company name”, an “address”, a “attribute of a company”, a “uniform resource locator (URL)”, a “section/person in charge”, an “E-mail address”, a “telephone/facsimile (TEL/FAX)”, an “account information”, an “amount of security”, an “date of initial registration”, a “date of a latest use ”, and a “number of use” are stored.

The user database 115 includes information relating to the user. The user registers a company name, an address, a person in charge, a service area, a population in an area, and the like in the user database 115. Furthermore, the user database 115 includes a cumulative audience surveyed at a certain time interval. The cumulative audience is updated at each survey.

As shown in FIG. 6, in the user database 115, information on a user such as the “ID”, the “password”, the “company name”, the “address”, the “attribute of a company”, the “URL”, the “section/person in charge”, the “E-mail address”, the “TEL/FAX”, the “service area”, the “population in an area”, the “cumulative audience”, the “station power”, a “type of broadcasting station”, a “station ranking” indicating a ranking of the user, a “number of networks”, and an “attribute of a listener”are stored.

The user database 115 is associated with the administrative database 111, and stores information on a “registrant requesting broadcasting”, a “broadcast-requested music”, the “account information”, the “data of initial registration”, the “date of latest use”, and the “number of use”.

The clearing database 116 holds a detailed log of broadcast by the user. The clearing database 116 is prepared for each user, and for each log collection period. As shown in FIG. 7, in the clearing database 116, information on a “user name”, the “log collection period”, the “music to be broadcasted”, the “air time” of the music (contents), the “broadcasting frequency”of the music, the “music scheduled to be broadcasted”, and the “scheduled air time” are stored.

The information processing server 104 performs matching between the administrative database 111 and the user database 115. Specifically, the information processing server 104 performs matching by comparing the information on the “attribute of a target” in the administrative database 111 with the information on at least one item of the items in the user database 115, such as the “attribute of a company”, the “service area”, the “population in the area”, the “cumulative audience”, the “station power”, the “type of broadcasting station”, the “station ranking”, the “number of networks”, and the “attribute of a listener”, to determine whether these items match with each other.

The registrant transmits necessary information to the information processing server 104, so that various kinds of information and conditions relating to the music to be promoted (sales promotion) or advertised are registered in the administrative database 111. Furthermore, the registrant transmits necessary information to the information processing server 104, so that the advertising expenses (amounts) for the music are registered in the accounting database 113. The advertising expenses are valid only for the term of validity of the music registered in the administrative database 111.

The user may be able to refer only to the information of a registrant who has requested broadcasting to own station of the user. The user then selects pieces of music required for program scheduling, from among the music requested, and receives the information relating to the music selected from the information processing server 104, and broadcasts the music from the own station. The user can obtain fixed amount of money from the advertising expenses pooled by the registrant. The amount of money is calculated by the information processing server 104. The amount of money is different depending on the station power of the user.

When the music scheduled to be broadcasted is determined, the user transmits necessary information to the information processing server 104, so that the music scheduled to be broadcasted and the scheduled air time are recorded in the source database 112 in order to inform the registrant. At the time of broadcasting, the user obtains a music file to be broadcasted, from the administrative database 111 and the source database 112. Necessary information is transmitted to the information processing server 104 so that upon actual broadcasting, a broadcasting history is stored in the source database 112.

A broadcast log stored in the source database 112 is automatically extracted and recorded in the clearing database 116 as a detailed history file for each user. The registrant can confirm that music of the registrant has been broadcasted by referring to the history file. The registrant can also compare the history file with on-air schedule data of the user. Since the term of validity is set for the advertising expenses, if the music is not broadcasted within a certain period of time, the advertising expenses are directly returned to the registrant.

FIG. 8 is a block diagram of a hardware configuration of the information processing server 104, which is the apparatus for supporting sales promotion and advertisement according to the embodiment, and the information-processing terminal units 105 and 106. As shown in FIG. 8, the information processing server 104 and the information-processing terminal units 105 and 106 include a central processing unit (CPU) 801, a ROM 802, a RAM 803, a hard disk drive (HDD) 804, a hard disk (HD) 805, a flexible disk drive (FDD) 806, a flexible disk (FD) 807 as one example of a detachable recording medium, a display 808, the I/F 809, a keyboard 811, a mouse 812, a scanner 813, and a printer 814. Each of components is connected through a bus 800.

The CPU 801 controls of the information processing server 104 or the information-processing terminal unit 105 or 106. The ROM 802 stores programs such as a boot program. The RAM 803 is used as a work area of the CPU 801. The HDD 804 controls read/write of data from/to the HD 805, under control of the CPU 801. The HD 805 stores data written under control of the HDD 804.

The FDD 806 controls read/write of data from/to the FD 807 under control of the CPU 801. The FD 807 stores data written under control of the FDD 806, or allows the data recorded in the FD 807 to be read by the information processor. As the detachable recording medium, not only the FD 807, but also a compact disc-read-only memory (CD-ROM) (or compact disc-recorable (CD-R), or a compact disc-rewritable(CD-RW)), a magneto optical (MO) disk, a digital versatile disk (DVD), or a memory card may be used. The display 808 displays not only a cursor, icons, or toolboxes, but also windows (browsers) relating to data such as document, images, and functional information. The display 808 is, for example, a cathode ray tube (CRT), a thin film transistor (TFT), a liquid crystal display (LCD), or a plasma display (PD).

The I/F 809 is connected to a network 100 such as a local area network (LAN) or the Internet via a communication line 810, and connected to other servers and information-processing terminal units. The I/F 809 controls the interface between the network 100 and the information processing server 104 or the information-processing terminal unit, and controls input and output of data from other servers and information terminal units. The I/F 809 is for example a modem.

The keyboard 811 includes keys for inputting characters, figures, and various types of instructions, for inputting data. The keyboard 811 may be a touch panel input pad or numeric key pad. The mouse 812 is for moving the cursor, selecting ranges, moving windows, or changing a size of the windows. As long as same function as a pointing device can be achieved, a trackball, a joystick, a cross-shaped key, or a jog dial may be used.

The scanner 813 optically reads images, and captures image data into the information processor. The printer 814 prints image data or document data. For example, the printer 814 is a laser printer, or an ink jet printer.

The information-processing terminal units 105 and 106 may be a personal computer, or a portable information-processing terminal unit, for example, a mobile phone. When the information-processing terminal units 105 and 106 are the mobile phones, the I/F 809 controls transfer of radio waves to/from a radio base station (not shown), and is connected to the network 100, and to the information processing server 104 via the network 100. The I/F 809 controls an interface between the network 100 and the information-processing terminal unit, and controls input/output of data to/from other information processing servers. Furthermore, the I/F 809 may include a microphone and a speaker (not shown), for realizing the function as a telephone. The microphone inputs voice by converting the voice into electric signals. The speaker outputs the voice.

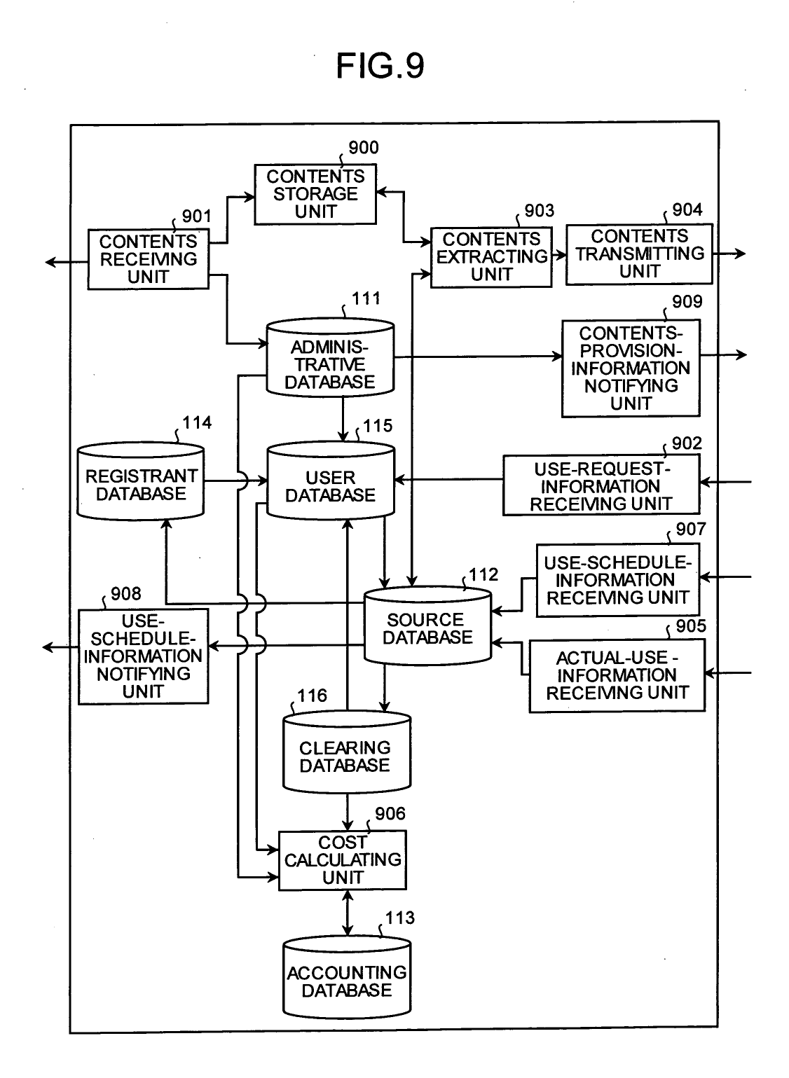

FIG. 9 is a block diagram of a functional configuration of the information processing server 104, which is the apparatus according to the embodiment of the present invention. As shown in FIG. 9, the information processing server 104 includes a contents storage unit 900, a contents receiving unit 901, a use-request-information receiving unit 902, a contents extracting unit 903, a contents transmitting unit 904, an actual-use-information receiving unit 905, a cost calculating unit 906, a use-schedule-information receiving unit 907, a use-schedule-information notifying unit 908, and a contents providing information notifying unit 909.

The contents receiving unit 901 receives contents information provided by a contents provider, that is, contents information transmitted from the information-processing terminal unit 105 of the registrant via the network 100, and stores the contents information received in the contents storage unit 900. The contents information is computerized works, and specifically, music data and image data. A function of the contents storage unit 900 is realized by, for example, the ROM 802, the RAM 803, the HD 805, and the FD 807 shown in FIG. 8.

The contents storage unit 900 may be provided in the information processing server 104. The contents storage unit 900 may be provided separately from the information processing server 104 in such a manner that the information processing server 104 and the contents storage unit 900 can be connected through the I/F 809.

The contents receiving unit 901 receives contents providing information relating to the sales promotion and advertisement of the contents information, including the information (attribute of a target) relating to designation of one or a plurality of mass-media institution, such as a broadcasting station, from the information-processing terminal unit 105 of the registrant via the network 100. The contents receiving unit 901 stores the contents providing information received in the administrative database 111. The contents providing information is, for example, information on each of the items included in the administrative database 111 shown in FIG. 2.

The use-request-information receiving unit 902 receives information relating to a use request of the contents information transmitted from the information-processing terminal unit 106 of the user, which is the broadcasting station 103, via the network 100. The use-request-information receiving unit stores the information received in the user database 115. The information relating to the use request is stored as the items of “broadcast-requesting registrant” and the “broadcast-requested music” shown in FIG. 6.

The contents extracting unit 903 extracts contents information that corresponds to the use request from among the contents information received by the contents receiving unit 901, based on the information relating to the use request. Specifically, the contents extracting unit 903 specifies the “linked file” and the “source location” in the administrative database 111 based on the “broadcast-requested music” in the user database 115, and extracts the contents information from the contents storage unit 900 based on the information. The contents transmitting unit 904 transmits the contents information extracted by the contents extracting unit 903 to the information-processing terminal unit 106 of the user.

The actual-use-information receiving unit 905 receives information relating to the actual use by the broadcasting station 103 of the contents information transmitted by the contents transmitting unit 904 from the information-processing terminal unit 106 of the user via the network 100. The actual-use-information receiving unit 905 stores the information received in the source database 112. The information relating to the actual use is, for example, information on the “air time” and the “broadcasting frequency”.

The cost calculating unit 906 calculates cost to be paid by the record company 102 that provides the contents to the broadcasting station 103, based on the information relating to the actual use received by the actual-use-information receiving unit 905 and stored in the source database 112.

The cost calculating unit 906 may calculate the cost based on the contents providing information received by the contents receiving unit 901 and stored in the administrative database 111, and the information relating to the actual use.

The cost calculating unit 906 may calculate the cost based on at least one of the information relating to the actual use and the contents providing information, and the information relating to the use schedule received by the use-schedule-information receiving unit 907 and stored in the source database 112.

Specifically, for example, the cost calculating unit 906 may compare the information relating to the use schedule and the information relating to the actual use to calculate the cost to check whether the contents is used as scheduled. If the contents are used at difference time and at different frequencies from the ones scheduled, the cost to be paid may be set lower than a case in which the contents are used as scheduled.

Furthermore, the cost may be set such that if the broadcasting station 103 notifies the broadcasting schedule (use schedule) at an early stage to the record company 102, the broadcasting station 103 receives higher amount of the sales promotion cost than usual. The amount may be set to vary depending on how early the broadcasting schedule is notified. For example, if the broadcasting schedule is notified one month in advance, the amount may be increased by 20% from the amount in a case without notifying the broadcasting schedule, and if the broadcasting schedule is notified two weeks in advance, the amount may be increased by 10%.

The cost calculating unit 906 may calculate the cost based on the information relating to the station power from among information stored in the user database 115.

The use-schedule-information receiving unit 907 receives the information relating to the use schedule of the contents information by the broadcasting station 103 from the information-processing terminal unit 106 of the user via the network 100, and stores the information received in the source database 112. Specifically, the information relating to the use schedule is information of “music scheduled to be broadcasted” and “scheduled air time” in the source database 112 shown in FIG. 3.

The use-schedule-information notifying unit 908 notifies the registrant of the information relating to the use schedule received by the use-schedule-information receiving unit 907 and stored in the source database 112. The information relating to the use schedule is notified the registrant by sending an e-mail. The information relating to the use schedule may be notified in such a manner that data including the information is registered in a predetermined server connected to the network 100, and based on a data acquisition request from the registrant, the data corresponding to the data acquisition request is transmitted to the information-processing terminal unit 105 of the registrant. In this case, it is preferable that security be secured by using a password or the like.

The contents transmitting unit 904 may transmit the contents extracted by the contents extracting unit 903 to the broadcasting station 103, based on the information relating to the use schedule. Specifically, for example, the contents transmitting unit 904 transmits the contents to the broadcasting station 103 a predetermined period of time, for example, two hours, in advance of scheduled air time. As a result, the contents information is not obtained before the scheduled air time, thereby preventing misuse of the contents information. Furthermore, loss of the contents information, which may occur by obtaining the contents well before the scheduled air time, can be prevented.

The contents providing information notifying unit 909 notifies the broadcasting station 103, which is specified based on information such as the “attribute of a target”, of the information relating to the sales promotion and advertisement. The information relating to the sales promotion and advertisement are notified by sending an e-mail. The information relating to the sales promotion and advertisement may be notified in such a manner that data including the information is registered in a predetermined server connected to the network 100, and based on a data acquisition request from the user, the data that corresponds to the data acquisition request is transmitted to the information-processing terminal unit 106 of the user. In this case, it is preferable that the security may be secured by using a password or the like.

Functions of the contents receiving unit 901, the use-request-information receiving unit 902, the contents transmitting unit 904, the actual-use-information receiving unit 905, the use-schedule-information receiving unit 907, the use-schedule-information notifying unit 908, and the contents providing information notifying unit 909 are realized ,for example, by the I/F 809 shown in FIG. 8, and also by the CPU 801 by executing programs stored in the ROM 802, the RAM 803, the HD 805, and the FD 807.

Functions of the contents extracting unit 903 and the cost calculating unit 906 are realized, for example, by the I/F 809 shown in FIG. 8, and also by the CPU 801 by executing programs stored in the ROM 802, the RAM 803, the HD 805, and the FD 807.

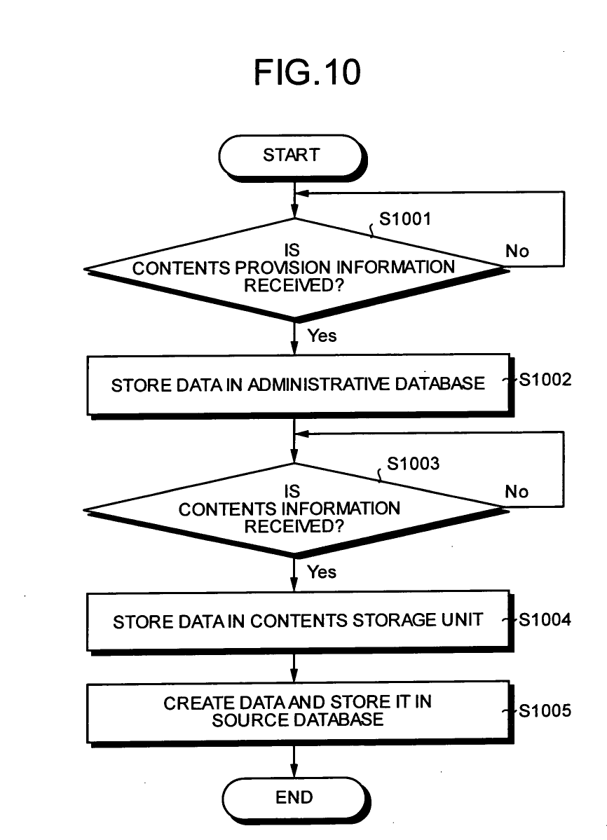

FIGS. 10 to 14 are flowcharts of processes performed by the apparatus according to the embodiment. FIG. 10 is a flowchart of a process for contents registration. As shown in FIG. 10, first, it is determined whether the contents providing information is received (step S1001). When the contents providing information is received (“YES” at step S1001), the contents providing information is stored in the administrative database 111 (step S1002).

Then, it is determined whether the contents information is received (step S1003). When the contents information is received (“YES” at step S1003) the contents information is stored in the contents storage unit 900 (step S1004). Then, information including a destination for storing the contents information (“source location”) in the contents storage unit 900 is created and store in the administrative database 111 (step S1005), to finish the process. Thus, the contents information can be collected.

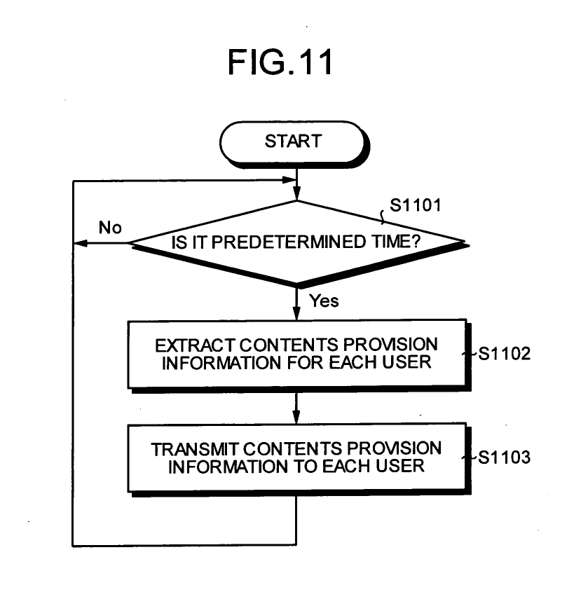

FIG. 11 is a flowchart of a process for notification to the user. As shown in FIG. 11, first, it is determined whether a predetermined time has come (step S1101). When the predetermined time has come (“YES” at step S1101), the contents providing information is extracted from the administrative database 111 for each user (step S1102).

Then, the contents providing information extracted is transmitted to the information-processing terminal unit 106 of each user (step S1103), and the process repeats steps at the steps S1101 to S1103. Thus, the contents providing information can be transmitted to each user.

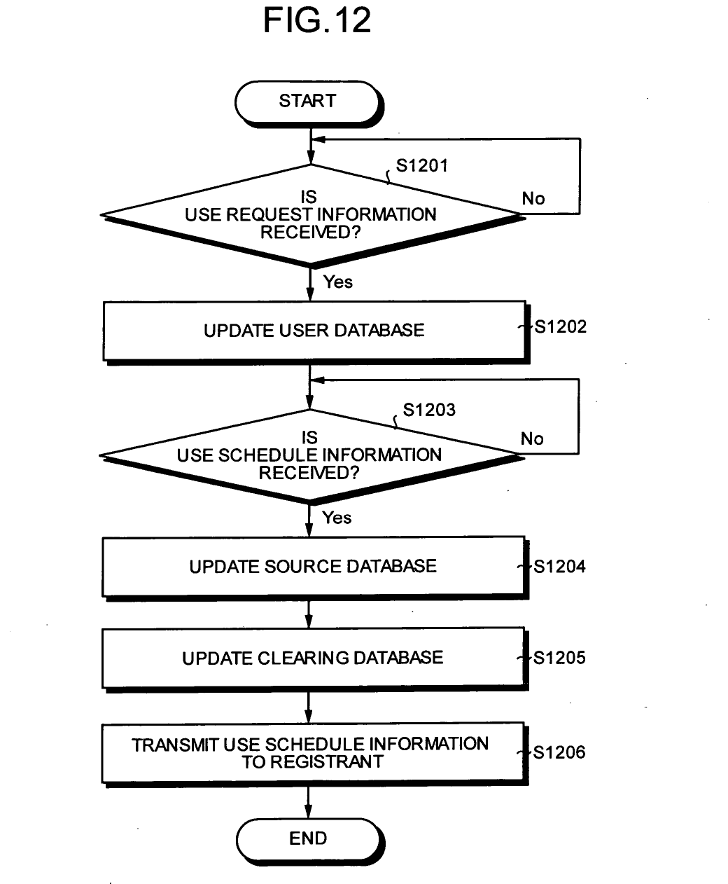

FIG. 12 is a flowchart of a process for registration of use request information. As shown in FIG. 12, first, it is determined whether the user request information has been received (step S1202). When the user request information is received (“YES” at step S1201), data in the user database 115 is updated based on the user request information received (step S1202).

Then, it is determined whether the use schedule information is received (step S1203). When the use schedule information is received (“YES” at step S1203), data in the source database 112 is updated based on the use schedule information received (step S1204). Then, data in the clearing database 116 is updated based on the data in the source database 112 (step S1205), and the use schedule information is transmitted to the information-processing terminal unit 105 of the registrant (step S1206), to finish the process. Thus, the user schedule information can be transmitted to the registrant.

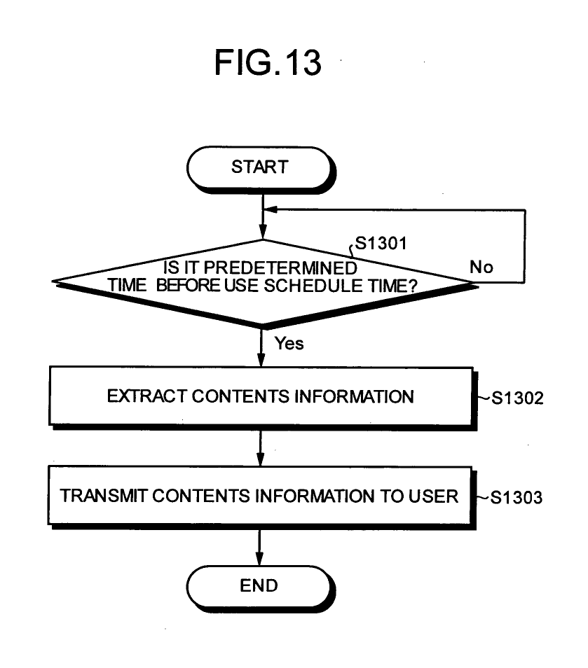

FIG. 13 is a flowchart of a process for transmission of contents. As shown in FIG. 13, first, it is determined whether time that is a predetermined period of time (for example, two hours) in advance of the use schedule time has come (step S1301). When the time has come (“YES” at step S1301), the contents information is extracted from the contents storage unit 900 (step S1302). Then, the contents information extracted is transmitted to the information-processing terminal unit 106 of the user (step S1303), to finish the process. Thus, the user can obtain the contents information at appropriate time.

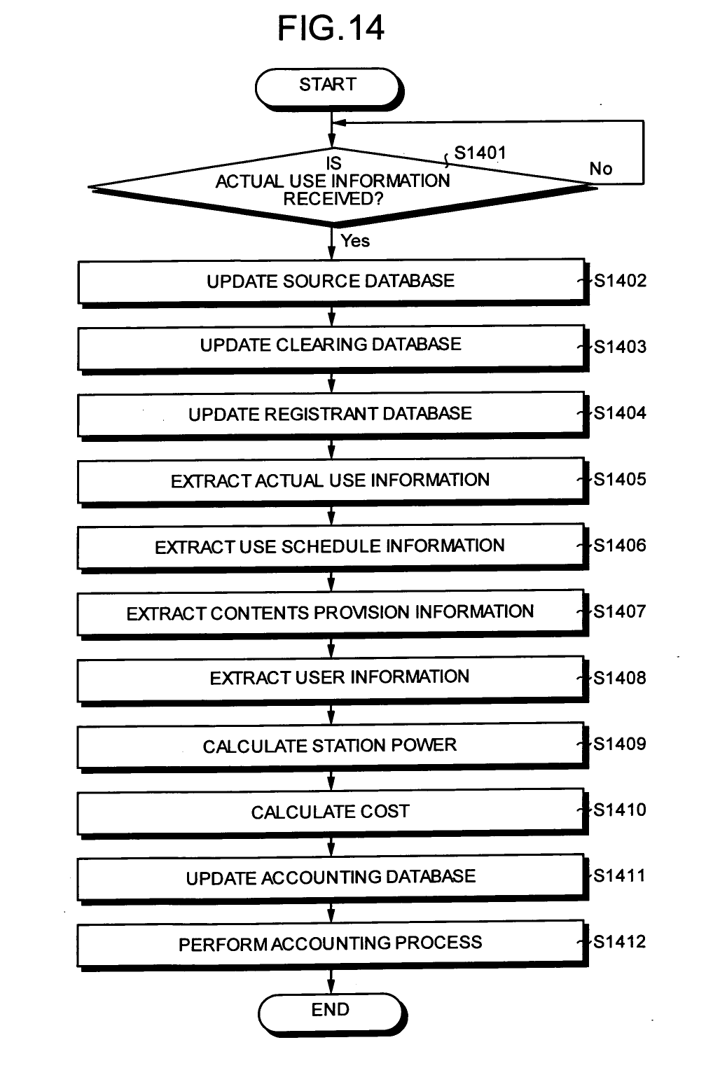

FIG. 14 is a flowchart of a process for cost calculation. As shown in FIG. 14, first, it is determined whether the actual use information is received (step S1401). When the actual use information is received (“YES” at step S1401), data in the source database 112 is updated based on the actual use information received (step S1402), and data in the clearing database 116 is updated based on the data updated (step S1403). Furthermore, data in the registrant database 114 is updated based on the data updated (step S1404).

Then, the actual use information and the use schedule information are extracted from the source database 112 (steps S1405 and S1406). The contents providing information is extracted, as necessary, from the administrative database 111 (step S1407). Moreover, the user information is extracted from the user database 115 (step S1408), and the station power is calculated based on the user information extracted (step S1409).

Then, an amount to be paid is calculated based on the actual use information, the use schedule information, the contents providing information, and the station power (step S1410). If sufficient time is available until a scheduled air date from a date on which the on-air schedule is notified, it is possible for the record company to perform the sales promotion independently. Therefore, in this case, conditions such as increase of the amount may be added in the calculation considering such advantages for the record company. Data in the accounting database 113 is updated based on a result of the calculation (step S1411), and an accounting process is performed (step S1412). In this manner, the broadcasting station 103 can obtain the cost based on the use of the contents information.

The station power that objectively indicating the power relationship of the broadcasting station based on the area that is covered by the broadcasting station, the number of audiences, and the time window is calculated by, for example, the following elements:
(1) a broadcasting area;
(2) a population of audience;
(3) an audience rating (for each time zone);
(4) an audience age (for each time window); and
(5) a number of nationwide networks.
   Value varies dynamically according to the broadcasting timing and the time window for the broadcasting.

For example, a frequency modulation (FM) broadcasting in Japan includes a large radio station of which programs can be received in metropolitan districts and a community station institutionalized in 1992. The large radio station covers the metropolitan areas, and the community station provides broadcasting in an area per unit of city, town, and village. Naturally, the large radio station has wide broadcasting areas, and advertising and promotional effects are expected to be high. Meanwhile, also with the community station, high advertising and promotional effects can be expected by special advertisement for a limited area.

The FM stations survey the cumulative audience at a certain interval using a research firm. For example, the FM stations in the metropolitan areas request research firms to perform a survey on the cumulative audience once in two months. By the survey, data that includes information on listening time window, an age group of the audience, and gender of the audience are obtained. Although at present, the community stations do not perform such survey, it is expected that the community stations also perform the survey in the future.

The cumulative audience and a share are obtained by adding the cumulative audience in a desired time window or in an air time of a program in a minimum unit, and dividing the added value by a number of points that is obtained by dividing a fraction of broadcast by a survey minimum unit.

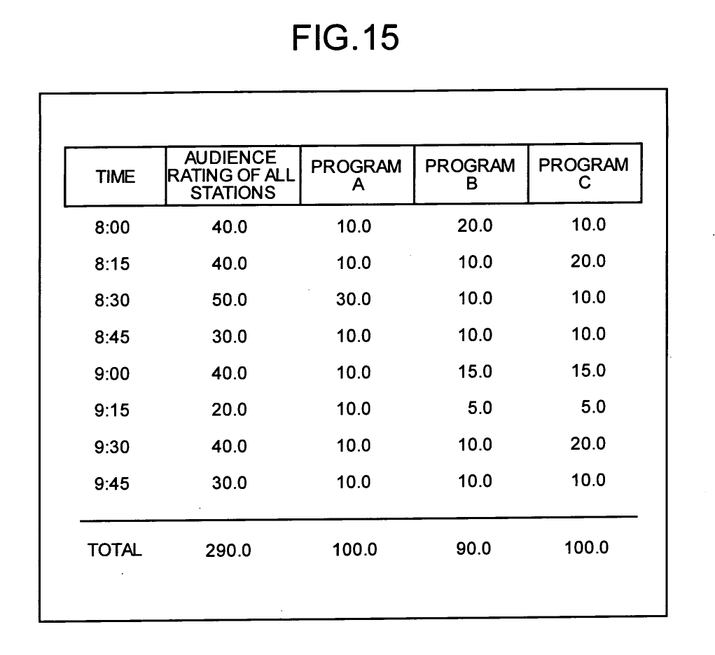

FIG. 15 is a list of cumulative audience (%) for programs in a 15-minute-time-window between 8:00 and 9:45. The cumulative audience of all stations refers to a percent of the radio turned on in the time window. With respect to program A, the result is as follows:
(a) a fraction of a broadcast since start of broadcasting of a program A: 8:00 to 10:00/120 minutes (min);
(b) a number of points for every 15 min: 120 min/15 min=8 points;
(c) a total value of cumulative audience for every 15 min in an air time of the program A: 100.0%;
(d) an average cumulative audience of the program A: 100.0/8=12.5%;
(e) a total value of cumulative audience for every 15 min of all stations at the air time of the program A: 290.0%; and
(f) a share of the program A: 100.0/290.0=34.5%.

When the station is linked with many local stations, such as a nationwide network, it can be considered as a factor of the station power. Thus, dynamic station power corresponding to a change in the period and time window can be calculated.

According to the embodiment, since the contents information is transmitted to the information-processing terminal unit 106 of the user, the distribution of the contents information, which is an object of the sales promotion and advertisement, is facilitated. Furthermore, since the cost calculating unit 906 calculates the sales promotion cost to be paid by the registrant, based on the station power calculated based on the actual use information, the use schedule information, the information stored in the administrative database 111, and the information stored in the registrant database 114, payment and receipt of an appropriate amount of the sales promotion cost becomes possible, thereby ensuring the equity in the sales promotion and advertisement. As a result, ambiguous setting for the advertising cost, which has been heretofore decided by agreement between the broadcasting station and the advertising agency, can be made clear, thereby enabling reduction of useless expenditures for the record company 102.

The sales promotion and advertisement are performed via the database center 101. Therefore, when the music is broadcasted, reliable records are made in the database center 101, and charging is made after the broadcasting. As a result, how the advertising expenses are spent becomes clear, thereby reducing useless expenditures. Moreover, since the sales promotion and advertisement are performed via the database center 101, and the term of validity is set for the advertising expenses, the advertising expenses can be used efficiently.

Since the broadcasting station 103 is only accessible to the advertising and promotional works, for which broadcasting is requested to the own station, it is possible to select music efficiently. Furthermore, the broadcasting station 103 can select music from a wide range from music from major labels to independent labels, thereby increasing variation in the selection of music, and the broadcasting station 103 may be able to find new artists efficiently.

Since the registrant can obtain the on-air schedule from the user, the registrant can perform independent advertisement and promotion before the schedule. Since the registrant can select the broadcasting station 103 as a pinpoint target, for example, when an artist or a publicity personnel goes on a tour for the advertisement and promotion, approach to the broadcasting station in the area becomes easy.

Promotion, which has heretofore aimed at about 1% of works, can be changed to target every possible work, thereby realizing effective promotion even by an individual. Furthermore, this method can expand the copyright businesses of all writers and copyright control organizations, and contribute to activation of local broadcasting stations and community broadcasting.

The method for supporting sales promotion and advertisement according to the embodiment may be realized with a computer-readable program prepared in advance, and the method may be realized by executing the program by a computer such as a personal computer or a workstation. The program is recorded on a computer-readable recording medium such as an HD, an FD, a CD-ROM, an MO, or a DVD. The method is realized by reading the program from the recording medium by the computer. The program may be a transmission medium that can be distributed via a network such as the Internet.

As explained above, according to the present invention, it is possible to obtain a method, a computer product, and an apparatus for supporting sales promotion and advertisement that enables efficient and fair sales promotion and advertisement using mass-media institutions for contents of contents providers.

Furthermore, according to the present invention, distribution of contents information, which is an object of the sales promotion and advertisement, is facilitated. Moreover, payment and reception of the sales promotion expenses based on the actual use becomes possible, and hence equity in the sales promotion and advertisement can be ensured.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A method for supporting activities of a sales promotion and an advertisement for contents, the activities performed by a contents provider through a mass-media institution, the method comprising:
receiving first contents information provided by the contents provider;
receiving request information for use of contents information from the mass-media institution;
extracting second contents information that corresponds to the request information from among the first contents information;
transmitting the second contents information to the mass-media institution;
receiving usage information on a record of an actual use of the second contents information by the mass-media institution; and
calculating a cost to be paid to the mass-media institution by the contents provider based on the usage information received.

2. The method according to claim 1, further comprising receiving schedule information on a schedule of use of the second contents information in the mass-media institution; and
notifying the contents provider of the schedule information received.

3. The method according to claim 2, wherein the calculating includes calculating the cost based on the schedule information and the usage information.

4. The method according to claim 1, further comprising receiving institution information on the mass-media institution, wherein the calculating includes calculating the cost based on the institution information.

5. A method for supporting activities of a sales promotion and an advertisement for contents, the activities performed by a contents provider through a mass-media institution, the method comprising:
receiving first contents information provided by the contents provider and contents providing information on the sales promotion and the advertisement of the contents information including specifying information for specifying a single mass-media institution or a plurality of mass-media institution;
receiving request information for use of contents information from the mass-media institution specified;
extracting second contents information that corresponds to the request information from among the first contents information;
transmitting the second contents information to the mass-media institution;
receiving usage information on a record of an actual use of the second contents information by the mass-media institution; and
calculating a cost to be paid to the mass-media institution by the contents provider based on the contents providing information and the usage information received.

6. The method according to claim 5, further comprising notifying each of the mass-media institutions specified of the request information.

7. The method according to claim 5, further comprising receiving schedule information on a schedule of use of the second contents information in the mass-media institution; and
notifying the contents provider of the schedule information received.

8. The method according to claim 7, wherein the calculating includes calculating the cost based on the schedule information, the request information, and the usage information.

9. The method according to claim 5, further comprising receiving institution information on the mass-media institution, wherein the calculating includes calculating the cost based on the institution information.

10. The method according to claim 5, further comprising receiving schedule information on a schedule of use of the second contents information in the mass-media institution, wherein the transmitting includes transmitting the second contents information to the mass-media institution based on the schedule information.

11. A computer program for supporting activities of a sales promotion and an advertisement for contents, the activities performed by a contents provider through a mass-media institution, the computer program making a computer execute:
receiving first contents information provided by the contents provider;
receiving request information for use of contents information from the mass-media institution;
extracting second contents information that corresponds to the request information from among the first contents information;
transmitting the second contents information to the mass-media institution;
receiving usage information on a record of an actual use of the second contents information by the mass-media institution; and
calculating a cost to be paid to the mass-media institution by the contents provider based on the usage information received.

12. A computer program for supporting activities of a sales promotion and an advertisement for contents, the activities performed by a contents provider through a mass-media institution, the computer program making a computer execute:
receiving first contents information provided by the contents provider and contents providing information on the sales promotion and the advertisement of the contents information including specifying information for specifying a single mass-media institution or a plurality of mass-media institution;
receiving request information for use of contents information from the mass-media institution specified;
extracting second contents information that corresponds to the request information from among the first contents information;
transmitting the second contents information to the mass-media institution;
receiving usage information on a record of an actual use of the second contents information by the mass-media institution; and
calculating a cost to be paid to the mass-media institution by the contents provider based on the contents providing information and the usage information received.

13. A computer-readable recording medium that stores a computer program for supporting activities of a sales promotion and an advertisement for contents, the activities performed by a contents provider through a mass-media institution, the computer program making a computer execute:
receiving first contents information provided by the contents provider;
receiving request information for use of contents information from the mass-media institution;
extracting second contents information that corresponds to the request information from among the first contents information;
transmitting the second contents information to the mass-media institution;
receiving usage information on a record of an actual use of the second contents information by the mass-media institution; and
calculating a cost to be paid to the mass-media institution by the contents provider based on the usage information received.

14. A computer-readable recording medium that stores a computer program for supporting activities of a sales promotion and an advertisement for contents, the activities performed by a contents provider through a mass-media institution, the computer program making a computer execute:
receiving first contents information provided by the contents provider and contents providing information on the sales promotion and the advertisement of the contents information including specifying information for specifying a single mass-media institution or a plurality of mass-media institution;
receiving request information for use of contents information from the mass-media institution specified;
extracting second contents information that corresponds to the request information from among the first contents information;
transmitting the second contents information to the mass-media institution;
receiving usage information on a record of an actual use of the second contents information by the mass-media institution; and
calculating a cost to be paid to the mass-media institution by the contents provider based on the contents providing information and the usage information received.

15. An apparatus for supporting activities of a sales promotion and an advertisement for contents, the activities performed by a contents provider through a mass-media institution, the apparatus comprising:
a first receiving unit that receives first contents information provided by the contents provider;
a second receiving unit that receives request information for use of contents information from the mass-media institution;
an extracting unit that extracts second contents information that corresponds to the request information from among the first contents information;
a transmitting(unit that transmits the second contents information to the mass-media institution;
a third receiving unit that receives usage information on a record of an actual use of the second contents information by the mass-media institution; and
a calculating unit that calculates a cost to be paid to the mass-media institution by the contents provider based on the usage information received.

16. An apparatus for supporting activities of a sales promotion and an advertisement for contents, the activities performed by a contents provider through a mass-media institution, the apparatus comprising:
a first receiving unit that receives first contents information provided by the contents provider and contents providing information on the sales promotion and the advertisement of the contents information including specifying information for specifying a single mass-media institution or a plurality of mass-media institution;
a second receiving unit that receives request information for use of contents information from the mass-media institution specified;
a storage unit that stores the contents providing information and the request information;
an extracting unit that extracts second contents information that corresponds to the request information from among the first contents information;
a transmitting unit that transmits the second contents information to the mass-media institution;
a third receiving unit that receives usage information on a record of an actual use of the second contents information by the mass-media institution; and
calculating a cost to be paid to the mass-media institution by the contents provider based on the contents providing information and the usage information.
